(19) United States
(12) Patent Application Publication
(10) Pub. No.: US 2025/0328857 A1
(43) Pub. Date: Oct. 23, 2025

(54) SYSTEM AND METHOD FOR AUTOMATED SELF STORAGE MANAGEMENT AND USER INTERACTION

(71) Applicant: 12947790 Canada Inc., Nobleton (CA)

(72) Inventors: Alexei Vlassov, Woodbridge (CA); Kirill Tsytsak, Nobleton (CA)

(21) Appl. No.: 18/640,615

(22) Filed: Apr. 19, 2024

(51) Int. Cl. G06Q 10/087; G06K 7/14

(52) U.S. Cl. CPC G06Q 10/087; G06K 7/1417

(57) ABSTRACT

The invention details a method and system for streamlining self-storage services, managed by a server with a processor, memory, and network interface. This approach includes processing storage requests by evaluating item metadata to determine storage eligibility and allocating approved items in storage facilities, using vertically arranged storage racks. Utilizing machine learning algorithms and artificial intelligence techniques, the system optimizes storage placement and adjusts storage facility layouts based on data analysis of historical trends and seasonal demands. Additionally, the system generates QR codes for simplified item check-in and retrieval, as well as continuous tracking of the item throughout its lifecycle within the storage facility. It also supports maintaining a digital catalog of household items, allowing users to easily submit storage or retrieval requests through a multifunctional application.

### FIELD OF THE INVENTION

The invention relates to the field of self-storage management systems, encompassing systems for automated storage allocation and streamlining user interaction through a multifunctional application.

### BACKGROUND OF THE INVENTION

The following description includes information that may be useful in understanding the present invention. It is not an admission that any of the information provided herein is prior art or relevant to the presently claimed invention, or that any publication specifically or implicitly referenced is prior art.

The efficient use of self-storage facilities and the modernization of storage facilities represent significant challenges in the logistics and warehousing industry. The construction of warehouses, as an alternative to traditional self-storage facilities, often proves to be easier and more cost-effective. Traditional approaches to storage management frequently result in the underutilization of available space and inefficient inventory processes. Furthermore, these conventional methods seldom leverage advanced technological solutions for optimizing storage layouts or facilitating user interaction with the storage system.

As a result, there is a growing demand for systems that not only maximize the use of storage areas but also incorporate automation to streamline operations. This includes the need for interactive software solutions that enhance the user experience, allowing for easier access to storage services and more effective management of stored items. The integration of such technologies promises to transform the self storage industry by improving operational efficiency, reducing manual errors, and offering users a more engaging and responsive service model.

Thus, there remains a need for a method and system that facilitates improved utilization of self-storage spaces and addresses the limitations of current practices. This includes overcoming challenges associated with space underutilization, enhancing the automation of storage facility operations, and providing an enriched or alternative user experience through a multifunctional software application.

### BRIEF DESCRIPTION OF DRAWINGS

Various objects, features, aspects, and advantages of the inventive subject matter will become more apparent from the following detailed description of preferred embodiments, along with the accompanying drawing figures in which like numerals represent like components.

FIG. 1 is a block diagram of a system architecture for a self-storage management system in accordance with an example of the present specification.

FIG. 2 is a view of a user using a multifunctional application in accordance with an example of the present specification, taking a photograph of an item.

FIG. 3 is a screenshot of the multifunctional application of FIG. 2, showing the check-in procedure of the item into off-site storage.

FIG. 4 is a screenshot featuring a QR code overlay on the application interface shown in FIG. 3.

FIG. 5 is a screenshot of a confirmation screen within the application of FIG. 2.

FIG. 6 is a screenshot of a listing screen within the application of FIG. 2, for sale directly from its off-site storage location.

FIG. 7 is a screenshot of a home catalog screen within the application of FIG. 2, providing an interface for viewing and managing stored items.

FIG. 8 is a flow diagram for the operational process of the self-storage management system of FIG. 1.

FIG. 9 is a flow diagram for the optimization process of storage space allocation within the self-storage management system of FIG. 1.

FIG. 10 is a perspective view of an interior of a storage facility featuring a racking system in accordance with an example of the present specification.

FIG. 11 is front view of the racking system of FIG. 10, equipped with doors.

### DETAILED DESCRIPTION OF THE INVENTION

This detailed description provides an explanation of the embodiments of the present specification. The present specification encompasses a variety of systems, methods, and non-transitory computer-readable media.

The present specification discloses a method and system for self-storage management services. According to one example, the system includes a server with a processor, memory, and network interface. The server receives storage requests and evaluates item metadata to determine storage eligibility and allocating approved items in storage facilities using vertically arranged storage racks. Using machine learning algorithms and artificial intelligence techniques, the system optimizes storage placement and adjusts storage facility layouts based on data analysis of historical trends and seasonal demands. Additionally, the system generates QR codes for simplified item check-in and retrieval, as well as continuous tracking of the item throughout its lifecycle within the storage facility. It also supports maintaining a digital catalog of household items, allowing users to easily submit storage or retrieval requests through a multifunctional application.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of features used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed considering the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

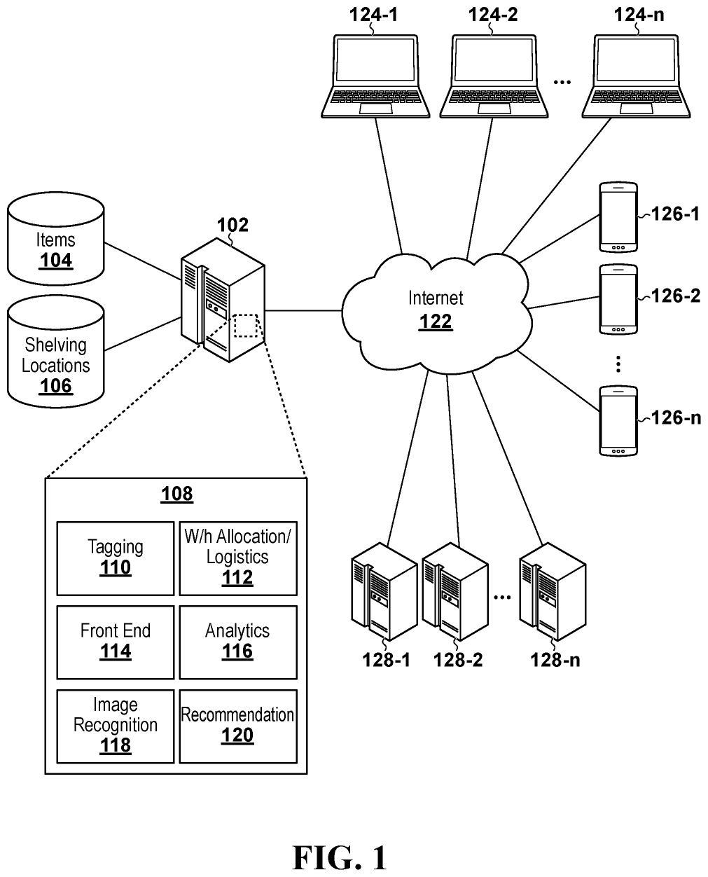

FIG. 1 illustrates a system 100 according to an example of the present specification that is designed for self-storage management. System 100 includes server 102 that manages requests and data across the system. The server 102 interacts with an item database (104) that holds information on stored items and a shelving/locations database (106) that tracks storage space availability and layout. The server 102 utilizes several modules: a tagging module (110) for item identification, a warehouse allocation/logistics module (112) for assigning storage spaces, a front end module (114) for user interface communication, an analytics module (116) for analyzing system data, an image recognition module (118) for generating item metadata from images, and a recommendation module (120) for providing user suggestions. The system operates over a network (122), such as the Internet, connecting the server 102 to client devices and third-party servers. Warehouse client devices (124-1 to 124-n) are used by staff for inventory management, while consumer client devices (126-1 to 126-n) allow users to interact with the system for various services. Third party servers (128-1 to 128-n) are integrated for additional functionalities such as value-added services as well as movers, couriers, charities, landfill, marketplace. This system is structured to improve the efficiency of managing storage requests and the allocation of items in storage facilities. The system 100 may include one or more processors, memory, and storage devices configured with software and/or firmware to implement the specified functionalities. The hardware is designed to support the computational demands of machine learning models, including, but not limited to, neural networks, decision trees, and support vector machines. The architecture described is exemplary and flexible, allowing for adaptation as hardware technologies and software requirements evolve.

The item database (104) within the system 100 stores information on items stored in the facility. It includes metadata such as size, weight, description, and unique identifiers for each item. This database supports operations like storage allocation, item retrieval, and inventory checks by providing necessary item details. The inclusion of such data aids in organizing and managing stored items, facilitating the process of locating and handling these items within the storage environment.

According to one example of the present specification, the shelving/locations database 106 maintains records on the spatial layout and availability of storage spaces within a facility. According to this example, this database 106 catalogs the specifics of shelving units and designated locations, enabling the organization of items according to size, category, and retrieval frequency. It assists in assigning items to appropriate storage areas, ensuring that space is used optimally and items are accessible when needed. The database 106 supports planning for space allocation and adjustments as inventory levels change. In this context, a facility refers broadly to any physical or virtual space managed by the system for the purpose of storing items. This can include warehouses, distribution centers, or any other premises adapted for the storage and management of goods, emphasizing flexibility in accommodating a variety of storage needs. The skilled reader will appreciate that while this example incorporates an internal database for these functions, the system is designed to be compatible with external storage management tools as well.

The tagging module 110 assigns unique identifiers or QR codes to items for tracking within the self-storage management system 100. These identifiers link items to their digital records in the item database (104), containing details such as characteristics and assigned storage locations. This process aids in managing inventory by making items identifiable through their digital tags, supporting the accurate and efficient handling of item check-ins, retrievals, and location updates. The use of digital tags helps in maintaining an organized approach to inventory management and operational procedures in the storage facility. A QR code (Quick Response code) is a type of matrix barcode that stores information as a series of pixels in a square-shaped grid, which can be read by an imaging device, such as a camera. Designed for quick readability and high storage capacity, QR codes are versatile in their application, encoding data ranging from simple text or URLs to more complex information. Use of the term digital tags encompasses enriched tags with data encryption, increased storage capabilities, and integration with emerging technologies such as augmented reality and blockchain.

According to one example of the present specification, unique QR codes are assigned to every item and box. These QR codes act as digital identifiers, streamlining the tracking and management of stored items. This method simplifies the identification and location tracking of items, eliminating the need for physical alterations to the storage units or the extensive infrastructure that traditional tracking systems might require. The QR code system enables more efficient retrieval and placement processes, improving the facility's operational efficiency by facilitating quick and precise item tracking.

According to some examples of the present specification, the system enables unregistered users to send messages to item owners by scanning the QR codes associated with each item. This functionality allows for inquiries regarding potential sales or for other communications concerning the item. This extension of the system's capabilities not only facilitates direct interaction between item owners and interested parties but also potentially enhances the utility and commercial viability of stored items. Advantageously, this interaction is supported within the existing infrastructure of the system, ensuring privacy and security without necessitating user registration.

The warehouse allocation/logistics module (112) manages the assignment of storage spaces within the facility and oversees the logistics of item movement. This module utilizes data from the shelving/locations database (106) to determine the most suitable storage locations for items based on their size, weight, and specific storage requirements. It also coordinates the physical movement of items to and from their allocated spaces, ensuring efficient use of the storage facility's capacity and facilitating easy access for item retrieval. By integrating information on storage space availability with the characteristics of stored items, the module aids in optimizing the layout of the storage facility and streamlining the overall storage process. This contributes to maintaining an orderly storage environment and supports the system's goal of efficient inventory management.

According to one example of the present specification, the warehouse allocation/logistics module (112) is responsible for subdividing shelf space into fixed volume units, similar to traditional self-storage offerings such as 5×5, 5×10, and 10×10 feet units. This allows for a tailored approach to storage, catering to various customer needs and maximizing the utilization of available space. By offering units in standard sizes, the system can integrate into existing storage practices while providing the advantages of precision in size and allocation.

The front end module (114) serves as the primary interface between users and the self-storage management system. It encompasses the visual and interactive elements through which users interact with the system, such as websites or mobile applications. This module is designed to offer a user-friendly experience, enabling customers to submit storage requests, view the status of their stored items, and manage their accounts with ease. It provides intuitive navigation and access to system functionalities, ensuring that information is clearly presented and actions can be performed with minimal effort. Additionally, the front end module facilitates direct communication with the system's backend services, ensuring that user inputs are processed accurately and responses are promptly delivered.

The analytics module (116) processes and analyzes data collected by the self-storage management system to enhance decision-making and improve service offerings. It reviews patterns in user behavior, storage utilization, and operational efficiency, providing insights that inform strategic adjustments and innovations. By aggregating data from various sources within the system, such as storage requests, item check-ins, and user interactions, this module identifies trends and anomalies that can lead to optimized storage solutions and tailored user experiences. The insights gained through analytics support the refinement of storage allocation strategies, the anticipation of user needs, and the identification of opportunities for service enhancement. Additionally, the analytics module can contribute to predictive models that forecast demand, helping to manage resources effectively and maintain high levels of service quality.

The analytics module (116) of the system harnesses machine learning and AI technologies to refine item placement and expedite the fulfillment of customer orders. Optimization goals include identifying item categories with high demand based on historical data to prioritize their placement for swift retrieval, managing seasonal demand fluctuations by adjusting storage configurations for items based on their seasonal relevance, and recognizing items frequently requested together to suggest their collocation for efficient retrieval. To achieve these objectives, the module develops and continually refines predictive models using statistical data sets, enhancing warehouse organization and operational efficiency. The incorporation of additional data sets into these models allows for ongoing optimization, with multilayer perceptron neural networks identified as a primary tool for implementation. This adaptive approach ensures the system's capacity to improve item localization strategies and warehouse organization dynamically, responding effectively to both new inventory and seasonal variations. Through this analytical framework, the system aims to optimize storage space use and streamline customer order fulfillment, leveraging data-driven insights to meet evolving storage needs and operational challenges.

Multilayer perceptron (MLP) neural networks, a class of feedforward artificial neural networks, consist of multiple layers of nodes in a directed graph, with each node representing a neuron that uses a nonlinear activation function. MLPs are distinguished by their ability to learn and model nonlinear relationships between input and output data through a process of training on a dataset, making them suited for complex pattern recognition tasks that are not linearly separable. When applied to the context of optimizing storage and retrieval processes within a self-storage management system, MLP neural networks offer significant advantages. They can analyze vast amounts of data, identifying intricate patterns and dependencies such as seasonal demand fluctuations, item retrieval frequencies, and optimal item placements that might not be immediately apparent. This capability allows for the dynamic optimization of warehouse organization, ensuring that storage spaces are utilized efficiently, and items are placed in a manner that reduces retrieval times and enhances overall operational efficiency. The use of MLP neural networks in this context can lead to surprising improvements in system responsiveness and customer satisfaction by enabling more accurate predictions and smarter decision-making in real-time.

In the field of optimizing storage and retrieval operations, the concept of caching-traditionally used in computing to improve access times to data-offers some insights. By employing various algorithms to dictate the allocation of items within storage facilities, the system effectively adapts caching principles to physical inventory management. This strategic approach enables the system to meet diverse storage needs and enhance operational efficiency through the following methods:
Last In, First Out (LIFO): This algorithm gives priority to the retrieval of the most recently stored items, making it particularly suitable for items with short-term storage needs. By ensuring that the last items placed into storage are the first to be retrieved, LIFO can streamline the handling of goods that are frequently rotated or updated.
First In, First Out (FIFO): FIFO is instrumental for items expected to remain in storage for extended periods. It ensures that items stored earlier are retrieved first, which is crucial for managing perishable goods or seasonal items that need to be used or sold within a specific timeframe to prevent loss or waste.
Least Frequently Used (LFU): The LFU algorithm allocates storage based on the frequency of retrieval requests for each item. By identifying items that are seldom requested, LFU helps optimize the use of storage space, reserving the most accessible locations for items with higher demand.
Most Frequently Used (MFU): Conversely, MFU focuses on items with high retrieval rates, placing them in locations that facilitate quick access. This method is effective in reducing retrieval times for popular items, thus enhancing customer service and operational throughput.
Random Replacement (RR): For items with unpredictable retrieval patterns, RR offers a flexible approach by randomly selecting items for relocation. This algorithm can be useful in managing storage space dynamically, accommodating fluctuations in item popularity or demand.

By leveraging these algorithms, the storage management system can mimic the efficiency of data caching in a physical context, optimizing the placement and retrieval of items in a way that significantly improves space utilization, reduces retrieval times, and adapts to varying item demands.

Still with reference to FIG. 1, the image recognition module (118) is an optional module that uses image processing technologies to analyze photographs of items submitted by users through the system's interface. This module automatically extracts valuable metadata from the images, such as dimensions, condition, and category of the items, thereby streamlining the process of item cataloging and storage allocation. By converting visual information into actionable data, the image recognition module enhances the accuracy of storage recommendations and facilitates the efficient organization of items within the facility. This automated approach to metadata generation not only reduces the need for manual data entry but also improves the overall user experience by simplifying the submission process. The module's capabilities allow for adaptation to diverse item types and characteristics.

The recommendation module (120) within the self-storage management system provides users with suggestions based on their usage patterns and the data collected by the system. It uses analytics to understand user behavior and storage trends, offering advice on when to store or retrieve items, which items might be suitable for disposal or donation, or alternative storage options that could meet their needs more effectively. This module relies on analyzing user interactions and storage histories to produce these recommendations, aiming to assist users in managing their storage space more effectively. By aligning its suggestions with observed user needs and behaviors, the recommendation module helps in improving space utilization within the facility and making the storage management process more user-friendly.

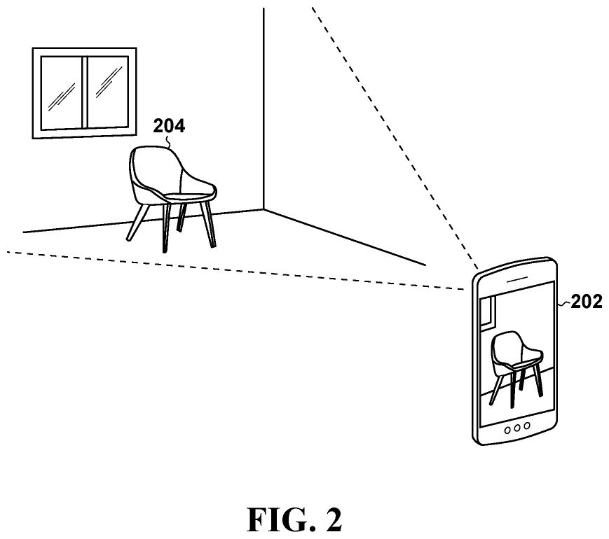

FIG. 2 depicts a user utilizing a mobile application, according to an example of the present specification, to photograph a sofa. This captures the moment when the user, through their smartphone, aims the camera at the sofa intending to submit this visual information to the system 100. Upon uploading of the photograph, it will then be analyzed by the system's Image Recognition Module to generate and record relevant metadata about the sofa, such as its dimensions and condition. This step is part of the item's initial cataloging process, facilitating its subsequent storage and management within the facility. It should be noted that the use of an image recognition module is illustrative and not prescriptive; the system's design permits the integration or omission of such technological components as needed, without affecting the overall functionality and scope of the present specification.

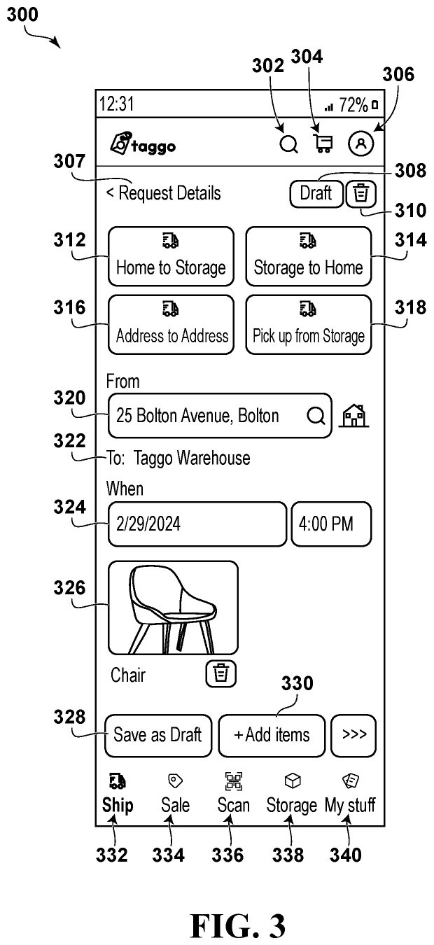

FIG. 3 shows the check-in interface 300 of the mobile application according to an example of the present specification, in this case demonstrating the storage process of a sofa. The interface is structured to provide users with a pathway for submitting items, starting from the top ribbon that has essential navigational buttons: a search function (302) for quick access to system features, a shopping cart (304) indicating selected services, and an account profile (306) for adjusting personal settings. Users have the convenience of saving their progress with a draft button (308) or removing unwanted entries via a delete button (310). The interface 300 offers diverse logistic options to cater to user needs: “Home to Storage” (312) for standard storage requests, “Storage to Home” (314) for retrieving items back to the user's location, “Address to Address” (316) facilitating transfers between different locations, and “Pick Up from Storage” (318) for direct item collection from the facility. Entry fields for the “from address” (320) and “to address” (322) allow users to specify item pickup and drop-off points, accompanied by a scheduling feature (324) to select convenient dates and times. An area for uploading photos (326) aids in documenting the item's condition pre-storage and also enables the system to populate metadata automatically, enhancing item tracking and management. Below, action buttons to “Save Draft” (328) and “Add Items” (330) enable users to manage their submissions. The bottom ribbon provides quick links to services like shipping (332), selling stored items (334), scanning QR codes for information or actions (336), accessing broader storage management options (338), and reviewing a personal catalog of stored items (340), providing users with a toolset for managing their storage needs.

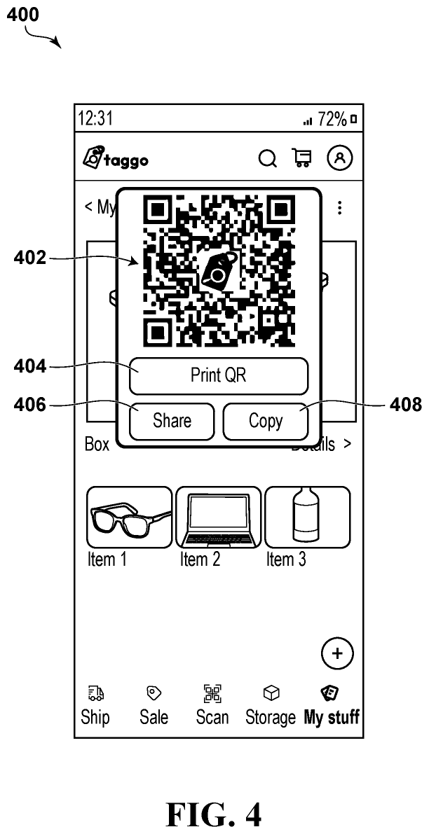

FIG. 4 displays an interface 400 within the mobile application of FIG. 3, where a QR code 402 appears as an overlay on the screen after completing the check-in process detailed in FIG. 3. This QR code 402 contains essential details of the storage request, including information about the item, such as the sofa, and logistical details like pickup and delivery addresses and times. The QR code is intended for use at the storage facility to simplify the check-in and retrieval processes. When scanned, it provides staff or automated systems with access to the storage request's specifics, to make the handling of items more straightforward and reduce processing times.

Additionally, the system includes the capability to establish partnerships with local convenience stores or other retail points to serve as third-party drop-off and pick-up points. This not only extends the reach and accessibility of the service but also benefits the participating stores through increased foot traffic and exposure. These strategically located points are especially advantageous in densely populated areas where traditional self-storage construction might not be feasible, offering convenience and accessibility to customers. Emphasizing the modern need for contactless operations, the system also supports contactless handling of items. Customers can deposit or retrieve their items at designated locations without direct human interaction by using mechanisms such as scanning a physical QR code or securing items in a receiving box, similar to the functionality of ecommerce pickup lockers. This method is not only efficient but also aligns with health and safety practices highlighted during scenarios like pandemic lockdowns.

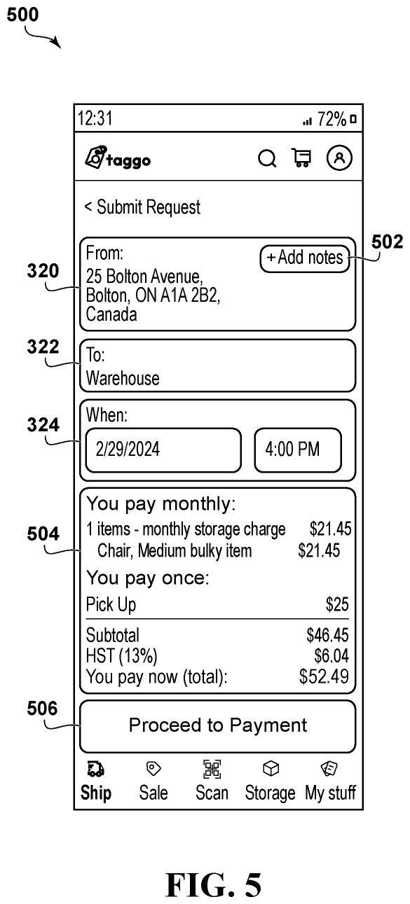

FIG. 5 shows a screenshot 500 from the mobile application of FIG. 3, during the final steps of setting up a storage request. It includes a button labeled “Add Notes” (502), allowing users to input any extra details or instructions about their storage needs. A section called “Payment Summary” (504) lists the costs associated with the request, providing a breakdown of the charges. Finally, a “Confirmation” button (506) is available for users to click once they're ready to finalize their request and optionally confirm payment. Users can add important details, review their payment obligations, and complete their storage arrangements with a confirmation action. According to some examples of the present specification, there is an option to finalize payments onsite, rather than in the mobile application.

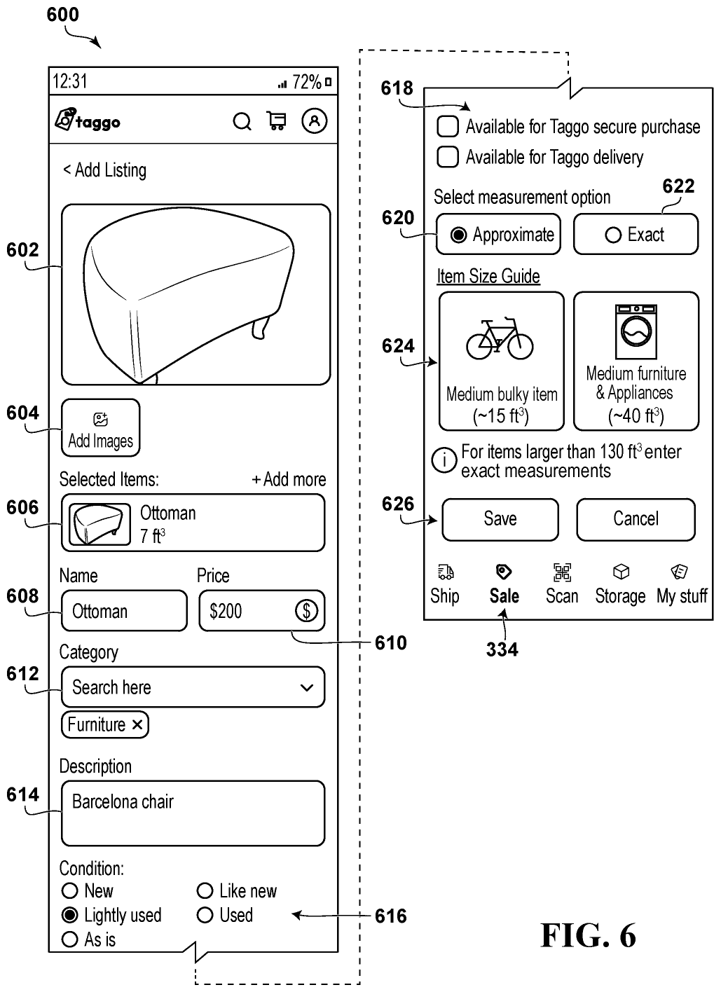

When the ribbon button (334) of FIG. 3 is pressed, as shown in FIG. 6, it triggers the mobile application to navigate to a screen designed for listing an item for sale, illustrated in the screenshot 600. The screen displays an item photo (602) at the top, giving a visual reference of the item intended for sale, with an “Add Images” button (604), allowing users to upload more photos for a better showcase. The “Selected Items” area (606) lists the items chosen for sale, including details such as the item name (608), in this example given as “ottoman,” and the asking price (610), marked as 200 dollars. Further information includes the item's category (612), listed as furniture, and a more detailed description (614), here noted as “Barcelona chair.” The item's condition (616) is specified as “lightly used,” providing potential buyers with an understanding of what to expect. Additionally, the screen offers the ability to buy or arrange delivery (618), and for sellers to indicate whether the size listed is approximate (620) or exact (622). A size toggle feature (624) allows the seller to classify the item's bulk or fit, for example, as “medium bulky” or “medium furniture.” At the bottom of the screen, “Save” or “Cancel” buttons (626) give users the flexibility to proceed with listing the item for sale or to abandon the process. Advantageously, this interface is designed to simplify the process of listing items for sale directly from storage, providing a pathway for users to enter all necessary information about their items and allowing an efficient transaction process.

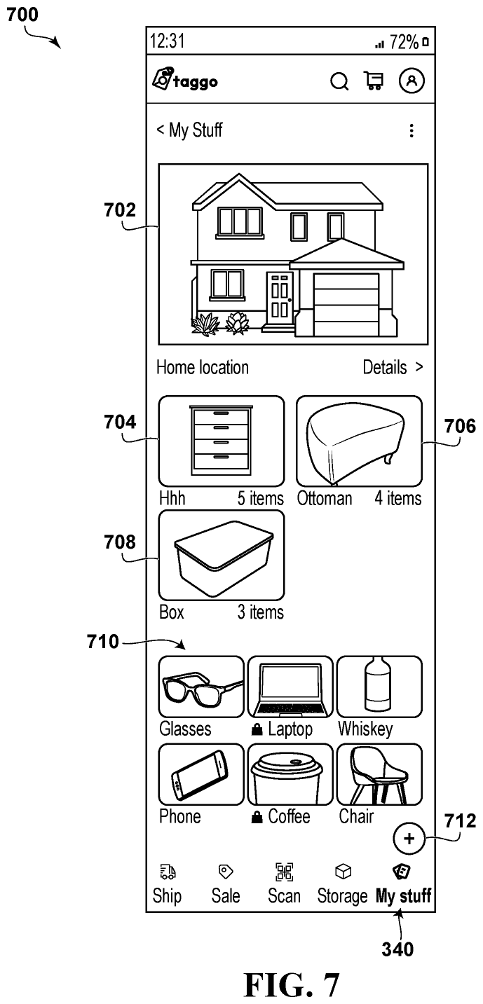

FIG. 7 illustrates the “My Stuff” or catalog function of the mobile application, accessed by clicking button 340 from FIG. 3, in accordance with an example of the present specification. This feature provides users with an organized overview of their items, both in storage and potentially for future storage. In screenshot 700, the interface depicts a location, such as a residence, (702), setting a personalized backdrop for the user's catalog. Displayed prominently are icons or images representing individual items currently managed through the application, in this example, a dresser (704), an ottoman (706), and a bin (708), serving as examples of the tangible items users have cataloged. Additionally, a designated region of the screen (710) lists more diverse items such as glasses, a laptop, whiskey, a phone, coffee, and a chair, illustrating the broad range of possessions that can be included in the catalog. The mobile application has the capability to manage a wide array of item types, from furniture to personal and household items. A “Plus” button (712) is placed to encourage users to continuously update and expand their inventory with new items, ensuring the catalog remains a comprehensive record of their belongings. This interactive catalog not only aids users in keeping track of their items but also streamlines the process of generating new check-in requests for storage. By clicking on any individual item within the catalog, users can initiate a check-in request, following the process detailed in FIG. 3, thereby transitioning from catalog management to storage management within the same application interface. This integration offers a practical and efficient method for users to manage their possessions, whether for storage or retrieval purposes.

The skilled reader will appreciate that the mobile application offers functional features aimed at simplifying the user's interaction with storage services. Users can schedule pickups or request deliveries of their items directly through the application, facilitating easy management of their storage needs. The application also provides a function for users to select specific items for retrieval, streamlining the process of getting items out of storage when necessary. Additionally, the application supports options for users to drop off their belongings at the facility or at predetermined locations, accommodating various user preferences. A built-in chat feature allows for direct communication with facility staff, addressing questions or concerns, thus improving the security and convenience of the service. Beyond basic storage management, the application includes a marketplace for users to sell or auction items, aided by insights on demand trends to inform selling strategies. Organizational tools extend the utility of the application to home or business inventory management, helping users keep track of their possessions. Advanced features, not shown in the drawings, leverage machine learning and analytics to customize the storage experience, predicting storage needs based on user behaviour and adapting recommendations to individual preferences, offering a more personalized approach to storage management.

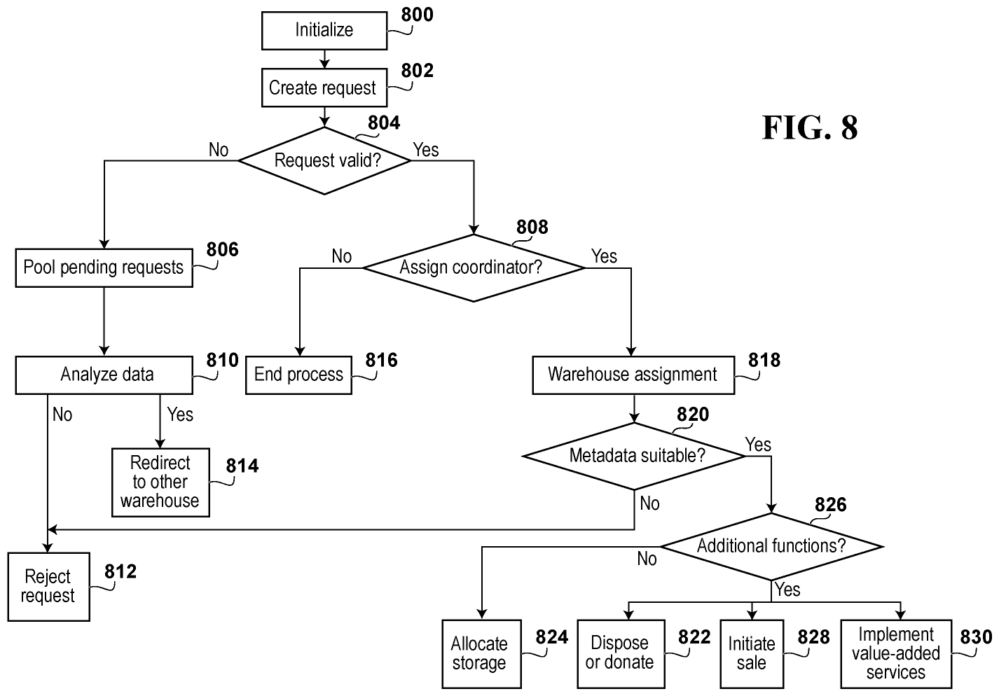

FIG. 8 illustrates a flow diagram for the operational process of a self-storage management system. The process begins with initialization (800) and progresses through creating a storage request (802). The request is then evaluated for validity (804), with invalid requests pooled for further analysis (806) and valid ones assigned a coordinator (808). Depending on the outcome, requests may be analyzed further (810), rejected (812), redirected to another warehouse (814), or proceed to warehouse assignment (818). The suitability of metadata is assessed (820), leading to storage allocation (824), disposal, or donation (822). Additionally, the diagram explores the decision to initiate sales (828) or implement value-added services (830) for items within the warehouse, demonstrating the system's multifaceted approach to optimizing storage management.

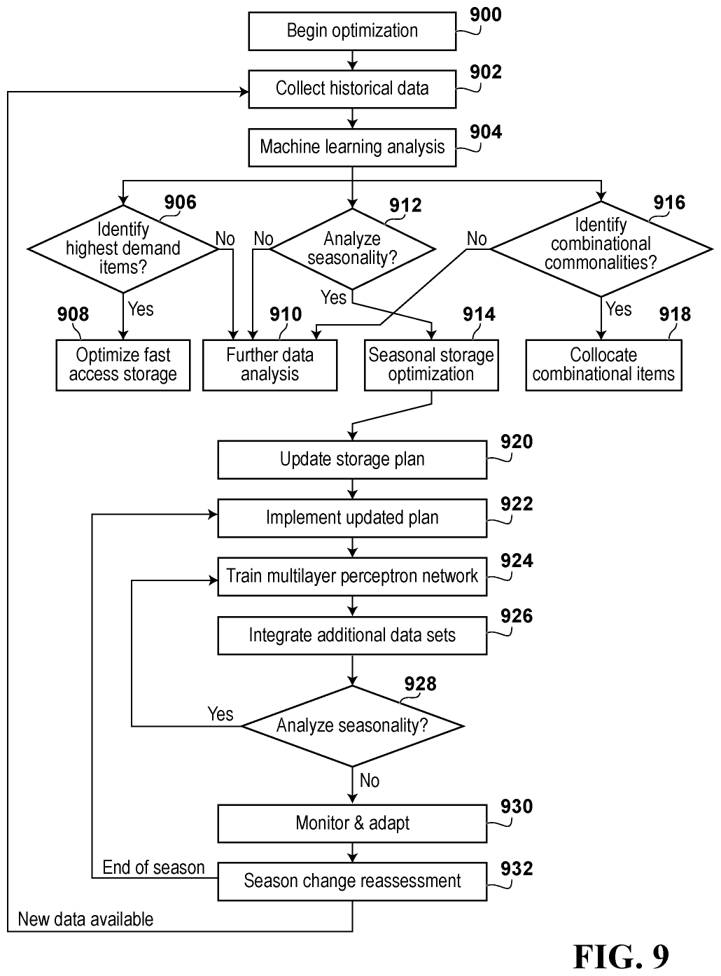

FIG. 9 presents a flow diagram detailing the optimization process for storage space allocation within a self-storage management system. The sequence initiates with the commencement of optimization (900) and advances through the collection of historical data (902). Machine learning analysis (904) follows, facilitating the identification of highest demand items (906) for optimization of fast access storage (908) and prompting further analysis (910) as needed. Additionally, the diagram addresses seasonality analysis (912) for seasonal storage adjustments (914) and the identification of items frequently requested together (916), leading to their collocation (918). Subsequent steps involve updating the storage plan (920), implementing the updated plan (922), and training a Multilayer Perceptron Network (924) with the integration of additional data sets (926) for continued optimization. The process includes provisions for ongoing monitoring, adaptation (930), and reassessment with seasonal changes or new data availability (932), illustrating a comprehensive approach to dynamic storage management optimization.

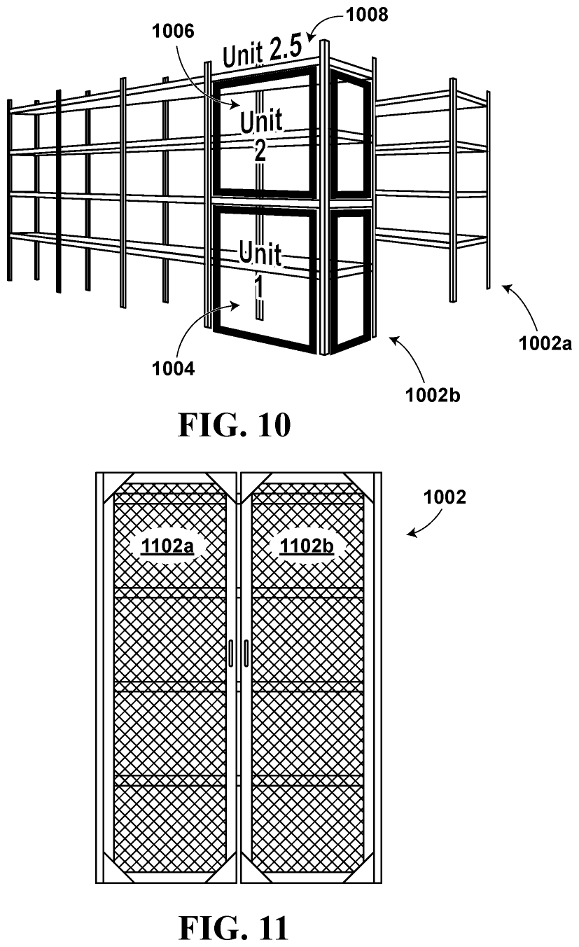

FIG. 10 illustrates the interior of a warehouse demonstrating a racking system according to one example of the present specification. The racking system includes racks 1002a and 1002b. These racks are designed to accommodate multiple storage units such as units 1004 (unit 1), 1006 (unit 2), and 1008 (unit 2.5), which are arranged vertically. In this example, a storage unit can include one or two shelves, optimizing the vertical space efficiently. FIG. 11 details these racks equipped with doors, 1102a and 1102b, which can swing open and be securely locked, ensuring the safety and confidentiality of the stored items. The doors 1102 can be mesh in one example. This arrangement supports a virtual layout of units, allowing for the sale of fixed storage spaces configured to any desired size, thus adapting traditional self-storage conveniences within a modern, controlled environment. The racking system, unlike fixed self-storage lockers, is reusable and resalable. This provides flexibility to repurpose or dismantle the setup according to changing business needs or market conditions. Advantageously, use of vertically structured storage unit system leverages existing layouts by stacking storage units, allowing facilities to expand their capacity vertically in constrained environments.

The system may process data through a series of computational steps, including data collection, cleaning, normalization, and analysis. Machine learning algorithms implemented on the system can analyze large datasets to identify patterns, make predictions, or generate recommendations based on the trained models.

Training of machine learning models involves feeding large datasets into the system, where the data is used to gradually adjust the model's parameters until it achieves the desired level of accuracy or performance. This training process can be performed using a variety of algorithms, including supervised, unsupervised, or reinforcement learning techniques, depending on the nature of the problem being addressed.

The system includes a user interface that allows users to interact with various functionalities, providing inputs, configuring settings, and receiving outputs. This interface can be web-based, mobile, or desktop applications, designed to facilitate user interaction with the underlying processes and to display the results of the analysis in an understandable and actionable manner.

The system can be implemented on cloud-based infrastructure, allowing scalable computing resources and storage capacity to accommodate the needs of large-scale applications. Networking technologies enable the system to access distributed data sources, integrate with other systems, and provide services to remote users over the Internet.

Advantageously, the storage unit consolidation techniques according to the present specification aim to use limited storage space more efficiently to enhance capacity and improve the handling of bulk storage. This is realized through a dynamic system that considers the metadata of each item stored. This system adopts an algorithmic strategy to decide how storage space is allocated, analyzing key pieces of item metadata such as size, weight, and how often items need to be accessed. With this information, the system can select the most suitable storage location for each item, aiming to make full use of available space. It calculates the space needed for each item and finds a matching spot in the storage facility that minimizes unused space while keeping items accessible. Adjustments to storage placements can be made in real-time, reacting to inventory changes like new additions or the removal of items. This flexibility ensures the storage operation stays efficient, aligning space allocation with the latest storage requirements. The detailed use of metadata allows the system to fine-tune how items are organized, optimizing how storage space is used. By moving away from fixed storage approaches to one that adapts to each item's unique requirements, the system cuts down on waste and improves the storage facility's overall capacity. Implementing this dynamic allocation method can lead to significant gains in how storage space is used, operational effectiveness, and customer satisfaction by ensuring a smarter, more responsive storage environment.

Traditional storage locker facilities often grapple with the challenge of underutilization due to their fixed, wall-defined spaces, leading to poor fill rates. The rigidity of these physical barriers means that storage units cannot adapt to the varying sizes and shapes of items, resulting in inefficient use of the available space. Consequently, while some lockers may be filled to capacity, others might remain only partially used, reflecting an uneven distribution of storage usage across the facility. This limits the facility's overall efficiency and capacity, as the predetermined locker sizes cannot accommodate a more flexible approach to storing items based on their specific dimensions and storage requirements. The inability to dynamically adjust space according to the actual needs of the items being stored not only results in wasted space but also restricts the facility's ability to maximize its storage potential and offer more cost-effective solutions to its customers.

To overcome the challenges of security and privacy in optimizing storage space, the system could introduce the use of sealable bins, similar to bank deposit boxes where the customer has the only key. These bins, which could vary in size to accommodate different items, would allow for items to be securely stored and efficiently organized within the facility. Each bin would be secured with a lock, which could be a smart lock, for which only the customer has the key or access code, ensuring privacy and security. The facility could then dynamically arrange these bins to optimize space usage without needing to access the contents, addressing privacy concerns while improving fill rates. This approach maintains customer trust by safeguarding their items' security and privacy, akin to the confidentiality provided by a bank's safety deposit box.

Additionally, access to storage units is digitally controlled, leveraging QR codes for secure and efficient entry. Inventory management ensures each item's location is always known, aiding in optimizing storage space and quickening item retrieval. The system's algorithms continuously analyze storage needs and item characteristics to adjust storage allocations in real time, thereby enhancing the precision and responsiveness of storage management. Through the innovative use of QR codes, storage facility operations become more scalable, flexible, and efficient, and offering improved security as well.

The skilled reader will appreciate that, unlike large-scale commercial warehouses that primarily focus on optimizing for rapid inventory turnover and logistic efficiency for new goods, self-storage facilities cater to a diverse range of personal and household items, each with unique storage durations and access frequencies. The technological systems developed for commercial warehouses often rely on uniformity in packaging and a predictable flow of goods, which are tightly integrated with an inventory management system optimized for e-commerce operations. These systems may not directly translate to self-storage environments, where item variability and customer-driven access patterns demand more flexible and personalized storage solutions. Additionally, the security and privacy concerns inherent in self-storage, where customers' personal belongings are involved, require a different approach to access control and inventory tracking. Techniques like dynamic space allocation, enhanced by machine learning for personalized storage recommendations, highlight the adaptation to the specific needs of self-storage customers, differing significantly from the automation strategies in commercial warehousing, which prioritize efficiency and speed over individual customization and privacy considerations.

One general aspect includes a method including the steps of: at a server including a processor, a memory, and a network interface device connected to a network, receiving, by the processor via the network interface device, a request from a user for self-storage services; determining, by the processor, whether the request includes metadata including size, weight, description, and eligibility for storage; upon determining the request is rejected, directing, by the processor, the request to a pending requests pool for additional analysis; upon determining the request is accepted, dispatching, by the processor, the request to a dispatch coordinator for processing; if the dispatch coordinator accepts the request, forwarding, by the processor, the request to a storage facility close to the provided address or alternatively to an address selected by the user; analyzing, by the processor, the metadata associated with the accepted request to determine a suggested location for storage within the selected storage facility; allocating, by the processor, the item to a storage shelf within the storage facility based on the suggested location; identifying, by the processor, the request as a disposition request if the item is not suitable for storage; conducting, by the processor, internal warehouse functions including selling the item or coordinating value-added services. The method further includes utilizing, by the processor, a machine learning algorithm to optimize item placement and streamline the fulfillment of user requests based on historical request data, seasonality fluctuations, and identification of commonly requested item combinations; and includes reconfiguring, by the processor, the storage layout within the storage facility based on predictive analysis from the machine learning algorithm to accommodate future incoming requests and seasonality changes. According to some examples of the present specification, the storage facility can be a warehouse, a convenience store, a retail store, a kiosk, and a dedicated drop-off point. The storage facility can divide shelving racks into units that can be equipped with doors for secure locking.

Implementations may include one or more of the following features: generating a unique Quick Response (QR) code for each item or storage request. This QR code contains information about the item's metadata, user identification, and its designated storage location. The system displays this QR code on the user's electronic device through an application connected to the network, facilitating its presentation at a self-storage location. A scanning device at the storage location reads the QR code to verify the item's reservation, the identity of the user, and automates the check-in of the item into its designated spot. The QR code facilitates continuous tracking of the item throughout its lifecycle within the storage facility. Furthermore, including both disposal and donation requests within the disposition request options. Disposal requests direct items to environmentally responsible recycling or waste management processes. Donation requests allocate items to charitable organizations or entities in need of donations, promoting sustainable and socially responsible item disposition. Moreover, conducting a comprehensive review process for requests placed in the pending requests pool. This process evaluates the request against criteria such as space availability, specific storage conditions required by the item, and the potential for consolidating it with similar items. It also includes assessing the item's market value for sale or donation, its environmental impact if stored versus disposed of, and considering if the request should be redirected to an alternative storage solution or facility that better suits the item's needs. Additionally, maintaining a digital catalog of items designated for storage or retrieval, featuring detailed descriptions, photographs, historical usage data, and preferred storage conditions for each item. Through a user interface connected to the network, users can manage this catalog, submitting requests for shipping items to storage or retrieving them based on catalog entries. The system updates the storage plan and coordinates the physical movement of items to or from the warehouse according to the user's catalog management activities, enhancing the efficiency and user experience of storage management.

Further implementations may include the following additional features: Receiving digital images of an item from a user's electronic device via the network interface device. A machine learning algorithm is then employed by the processor to analyze these images and automatically generate metadata for the item. This metadata might include dimensions, weight, condition, and category of the item. Subsequently, this generated metadata is incorporated into the user's request, aiding in determining the item's eligibility for storage, the most suitable storage location, and the necessary handling requirements. Furthermore, coordinating with a network of storage facilities to identify the most appropriate storage location for an item, taking into account the item's metadata, the user's geographical location, and the availability of storage facilities. The assignment of items to specific facilities is optimized to distribute the storage load evenly, minimize transportation distances, and meet the specialized storage requirements of different items. Additionally, the system facilitates the movement of items between facilities to respond to fluctuating storage demands, retrieval requests, or to enhance storage efficiency through predictive analysis. Moreover, utilizing an artificial intelligence (AI) system as the dispatch coordinator, which processes storage requests based on factors such as geographical proximity, warehouse capacity, and specific handling requirements of the items. This AI system determines the most appropriate warehouse assignment and devises storage or disposition strategies for each request. The artificial intelligence (AI) system may utilize a multilayer perceptron neural network for processing requests. This neural network is trained on historical datasets, including past storage requests, warehouse performance metrics, seasonal demand patterns, and logistic efficiency outcomes. Based on this training, the AI system can dynamically adjust warehouse assignments and storage strategies, employing predictive analytics and real-time data processing to optimize operations. As well, the processor may use various algorithms to determine how items are allocated within the storage facilities. These include: a Last In, First Out (LIFO) algorithm for prioritizing the retrieval of the most recently stored items, suitable for short-term storage needs; a First In, First Out (FIFO) algorithm, to make sure that older items are retrieved before newer ones, for managing perishable goods or seasonal items; a Least Frequently Used (LFU) algorithm, allocating storage based on the frequency of item retrieval requests, thus optimizing space for items with variable demand; a Most Frequently Used (MFU) algorithm for items expected to have high retrieval rates, placing these in more accessible locations to expedite access; and a Random Replacement (RR) algorithm for items with unpredictable retrieval patterns, offering a versatile approach to storage allocation.

While the invention has been described with reference to the specific embodiments, it will be understood by those skilled in the art that various changes may be made without departing from the scope of the present specification. Furthermore, the scope of the present specification is not intended to be limited to the specific embodiments described herein. Additionally, the range of embodiments described herein is not intended to limit the scope of the present specification. Rather, the invention encompasses all modifications and variations within the scope of the present specification.

1. A method comprising the steps of:
at a server comprising a processor, a memory, and a network interface device connected to a network,
receiving, by the processor via the network interface device, a request from a user for self-storage services;
determining, by the processor, whether the request comprises metadata comprising size, weight, description, and eligibility for storage;
upon determining the request is rejected, directing, by the processor, the request to a pending requests pool for additional analysis;
upon determining the request is accepted, dispatching, by the processor, the request to a dispatch coordinator for processing;
if the dispatch coordinator accepts the request, forwarding, by the processor, the request to a storage facility close to the provided address or alternatively to an address selected by the user;
analyzing, by the processor, the metadata associated with the accepted request for determining a suggested location for storage within the selected storage facility;
allocating, by the processor, the item to a storage shelf within the storage facility based on the suggested location;
identifying, by the processor, the request as a disposition request if the item is not suitable for storage;
conducting, by the processor, internal warehouse functions comprising selling the item or coordinating value-added services;
wherein the method further comprises utilizing, by the processor, a machine learning algorithm to optimize item placement and streamline fulfillment of user requests based on historical request data, seasonality fluctuations, and identification of commonly requested item combinations; and
wherein the method further includes reconfiguring, by the processor, the storage layout within the storage facility based on predictive analysis from the machine learning algorithm to accommodate future incoming requests and seasonality changes.

2. The method of claim 1, wherein the storage facility is selected from: a warehouse, a convenience store, a retail store, a kiosk, and a dedicated drop-off point.

3. The method of claim 1, wherein allocating the item to a storage shelf within the storage facility involves arranging the shelves vertically.

4. The method of claim 3, further comprising equipping each of the vertically arranged shelves with doors that can be securely locked.

5. The method of claim 1, further comprising:
generating, by the processor, a unique Quick Response (QR) code for each item or request for storage, wherein the QR code encodes information related to the item's metadata, user identification, and designated storage location;
displaying, via a user interface on a user's electronic device application connected to the server through the network, the generated QR code for user presentation at a self-storage location; and
scanning, by a scanning device at the self-storage location, the QR code to verify the item's storage reservation, user identity, and to automate the check-in process of the item into the designated storage location;
wherein the QR code facilitates continuous tracking of the item throughout its lifecycle within the storage facility.

6. The method of claim 1, wherein the disposition request comprises either a disposal request or a donation request, wherein the disposal request comprises directing the item to environmentally responsible recycling or waste management processes, and the donation request comprises allocating the item to charitable organizations or entities seeking donations.

7. The method of claim 1, wherein the additional analysis of the request in the pending requests pool comprises a review process performed by the processor, comprising:
evaluating the request against additional warehouse criteria comprising space availability, specific storage conditions required by the item, and potential for consolidation with similar items;
conducting a market value assessment for potential sale or donation suitability;
assessing the environmental impact of storing versus disposing of the item; and
re-evaluating the request for redirection to an alternative storage solution or facility that matches the item's requirements.

8. The method of claim 1, further comprising:
maintaining, by the processor, a digital catalog of items designated for storage or retrieval, wherein the catalog includes detailed item descriptions, photographs, historical usage data, and preferred storage conditions;
enabling, via a user interface connected to the server through the network, a user to manage the catalog by submitting requests for shipping items to storage or retrieving items from storage based on the catalog entries;
wherein the server processes these requests to update the storage plan and coordinates the physical movement of items to or from the storage facility in accordance with the user's management of the catalog.

9. The method of claim 1, further comprising:
receiving, by the processor via the network interface device, digital images of an item from a user's electronic device;
employing, by the processor, a machine learning algorithm to analyze the digital image to automatically generate metadata for the item, wherein the metadata includes at least one of the item's dimensions, weight, condition, and category; and
incorporating, by the processor, the generated metadata into the user's request to facilitate the determination of the item's storage eligibility, optimal storage location, and handling requirements.

10. The method of claim 1, further comprising:
coordinating, by the processor, with a network of storage facilities to identify the most suitable storage location based on the item's generated metadata, user's geographical location, and storage facility availability;
optimizing, by the processor, the assignment of items to specific facilities within the network to balance load, minimize transportation distance, and align with specialized storage requirements of the items;
facilitating, by the processor, the transfer of items between facilities within the network to accommodate changes in storage demand, item retrieval requests, or to optimize storage efficiency based on predictive analysis.

11. The method of claim 1, further comprising utilizing an artificial intelligence (AI) system as the dispatch coordinator, wherein the AI system processes the request based on predetermined criteria comprising geographic proximity, warehouse capacity, and item-specific handling requirements, to determine warehouse assignment, storage or disposition strategy.

12. The method of claim 11, wherein the artificial intelligence (AI) system utilizes a multilayer perceptron neural network for processing the request, wherein the neural network is trained on historical data sets comprising past requests, warehouse performance metrics, seasonal demand patterns, and logistic efficiency outcomes, enabling the AI system to dynamically adjust warehouse assignments and storage strategies based on predictive analytics and real-time data processing.

13. The method of claim 1, wherein the processor utilizes one or more of the following algorithms to determine the allocation of items within the storage facilities:
employing a Last In, First Out (LIFO) algorithm to prioritize the retrieval of most recently stored items for items with short-term storage expectations;
implementing a First In, First Out (FIFO) algorithm for items that are expected to be stored for longer periods, providing that older items are retrieved before newer ones, for managing perishable goods or seasonal items;
utilizing a Least Frequently Used (LFU) algorithm to allocate storage based on the frequency of item retrieval requests, optimizing storage for items with varying demand levels;
applying a Most Frequently Used (MFU) algorithm for items anticipated to have high retrieval rates, positioning them in more accessible storage locations to reduce retrieval times;
and incorporating a Random Replacement (RR) algorithm for items with unpredictable retrieval patterns.

14. A system for optimizing self-storage services, comprising:
a memory storing instructions for managing user storage requests, generating metadata, conducting item analysis for storage suitability, allocating storage locations, managing disposition requests, and optimizing storage facility layout;
a network interface device for communicating with users and facilitating data exchange between the system and external sources; and
a processor configured to execute the instructions to:
receive a request from a user for self-storage services via the network interface device;
determine whether the request includes metadata comprising size, weight, description, and eligibility for storage;
direct the request to a pending requests pool for additional analysis upon rejection;
dispatch the request to a dispatch coordinator for processing upon acceptance;
forward the accepted request to a storage facility close to the provided address or alternatively to an address selected by the user if the dispatch coordinator accepts the request;
analyze the metadata associated with the accepted request to determine a suggested location for storage within the selected storage facility;
allocate the item to a storage shelf within the storage facility based on the suggested location;
identify the request as a disposition request if the item is not suitable for storage;
conduct internal warehouse functions including selling the item or coordinating value-added services;
utilize a machine learning algorithm to optimize item placement and streamline the fulfillment of user requests based on historical request data, seasonality fluctuations, and identification of commonly requested item combinations; and
reconfigure the storage layout within the storage facility based on predictive analysis from the machine learning algorithm to accommodate future incoming requests and seasonality changes.

15. At least one non-transitory computer-readable storage medium storing instructions that, when executed by at least one processor, cause the at least one processor to:
receive a request from a user for self-storage services via a network interface device;
determine if the request includes metadata that comprises size, weight, description, and eligibility for storage;
direct the request to a pending requests pool for additional analysis if the request is rejected;
dispatch the request to a dispatch coordinator for processing if the request is accepted;
forward the accepted request to a storage facility close to the provided address or to an address selected by the user, if the dispatch coordinator accepts the request;
analyze the metadata associated with the accepted request to determine a suggested location for storage within the selected storage facility;
allocate the item to a storage shelf within the storage facility based on the suggested location;
identify the request as a disposition request if the item is not suitable for storage;
conduct internal warehouse functions, including selling the item or coordinating value-added services;
utilize a machine learning algorithm to optimize item placement and streamline the fulfillment of user requests based on historical request data, seasonality fluctuations, and identification of commonly requested item combinations; and
reconfigure the storage layout within the storage facility based on predictive analysis from the machine learning algorithm to accommodate future incoming requests and seasonality changes.
